(19) United States
(12) Patent Application Publication
(10) Pub. No.: US 2004/0229511 A1
(43) Pub. Date: Nov. 18, 2004

(54) MEMORY CARD ADAPTER

(76) Inventor: Yuan-Hua Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/439,229

(22) Filed: May 16, 2003

(51) Int. Cl. H01R 25/00

(52) U.S. Cl. 439/638

(57) ABSTRACT

A memory card adapter is constructed to include a housing formed of a bottom cover shell and a top cover shell and compatible to the SD (Secure Digital) card slot of an electronic apparatus, a set of terminals mounted in the bottom cover shell, a cartridge fastened pivotally with the bottom cover shell and turned in and out of an opening in the top cover shell between a horizontal position and a lifted position and adapted to accommodate a mini memory card, and a retaining spring mounted in the bottom cover shell and adapted to lock the cartridge when the cartridge set in the horizontal position.

### BACKGROUND OF THE INVENTION

1. Field of the Invention

The present invention relates generally to a memory card adapter and, more particularly, to such a memory card adapter, which is adapted to accommodate a mini memory card and insertable in the SD (Secure Digital) card slot of an electronic apparatus.

2. Description of the Related Art

Various memory cards including CF (Compact Flash) cards, SM (Smart Media) cards, SD (Secure Digital) cards, multimedia memory cards, etc. have been developed for use with a variety of electronic apparatus such as PDAs, digital video cameras, digital cameras, etc. Different memory cards have different advantages and disadvantages. A CF card requires much installation space. A SM card requires less installation space than a CF card. The size of a multimedia memory card is similar to a SM card but relatively thicker. The read write speed of a multimedia memory card is faster than a CF card, however its cost is high. Recently, SD cards are most popularly accepted for the advantages of encryption function, small size, and high speed. A hardware supporting SD cards supports multimedia memory cards.

FIG. 1 illustrates the use of a SD card 102 in a PDA 100. A SD card 102 is thicker than a SM card, therefore requiring much installation space. In order to reduce the size, mini SD cards are developed. As illustrated in FIG. 1, a mini SD card 3 is much smaller than a conventional SD card 102. However, a mini SD card 3 is not compatible to the SD card slot 101 of a PAD 100. Therefore, a PAD 100 cannot use a mini SD card 3 directly.

### SUMMARY OF THE INVENTION

The present invention has been accomplished under the circumstances in view. It is the main object of the present invention to provide a memory card adapter, which is insertable to the SD (Secure Digital) card slot of an electronic apparatus to electrically connect a mini memory card to the electronic apparatus. To achieve this and other objects of the present invention, the memory card adapter comprises a housing shaped like a SD (Secure Digital) card and insertable to the SD (Secure Digital) card slot of an electronic apparatus, the housing comprising a bottom cover shell and a top cover shell covering the bottom cover shell, the bottom cover shell comprising a front terminal holder, a rear mini memory card chamber adapted to accommodate a mini memory card, a positioning portion in a rear side thereof, and a recessed portion in one lateral side thereof, the top cover shell comprising an opening corresponding to the rear mini memory card chamber of the bottom cover shell, a side hole, and a locating notch in one lateral side of the opening corresponding to the recessed portion of the bottom cover shell; a plurality of terminals respectively mounted in the terminal holder, the terminals each having a rear end respectively extended into the rear mini memory card chamber of the bottom cover shell; a cartridge mounted in the rear mini memory card chamber of the bottom cover shell of the housing and turned in and out of the opening of the top cover shell between a horizontal position and a lifted position and adapted to accommodate a mini memory card and to hold the inserted mini memory card in contact with the rear ends of the terminals when the cartridge set in the horizontal position, the cartridge comprising two lugs symmetrically provided at two opposite lateral sides thereof and respectively pivoted to two opposite lateral sides of the rear mini memory card chamber of the bottom cover shell, and a retaining strip located on one lateral side; and a retaining spring mounted in the bottom cover shell and adapted to lock the cartridge in the horizontal position, the retaining spring having a rear mounting end fixedly fastened to the positioning portion of the bottom cover shell, a front retaining end adapted to engage the retaining strip of the cartridge, and a protruding middle operation portion suspending in the side hole of the top cover shell for pressing by the user to disengage the front retaining end from the retaining strip of the cartridge.

### BRIEF DESCRIPTION OF THE DRAWINGS

FIG. 1 is an applied view of the present invention.

FIG. 2 is an exploded view of a memory card adapter according to the present invention.

FIG. 3 is an elevational assembly view of the memory card adapter according to the present invention.

FIG. 4 is a side view of FIG. 3.

FIG. 5 is an elevational view of a part of the present invention, showing the engagement between the retaining spring and the cartridge.

FIG. 6 is an enlarged view of part A of FIG. 5.

FIG. 7 is similar to FIG. 6 but showing the front retaining end of the retaining spring disengaged from the retaining strip of the cartridge.

FIG. 8 is another elevational view of the memory card adapter according to the present invention, showing the mini SD (Secure Digital) card and the cartridge set in the second (lifted) position.

FIG. 9 is a schematic drawing showing the cartridge turned from the first (horizontal) position to the second (lifted) position.

FIG. 10 shows an application example of the memory card adapter according to the present invention.

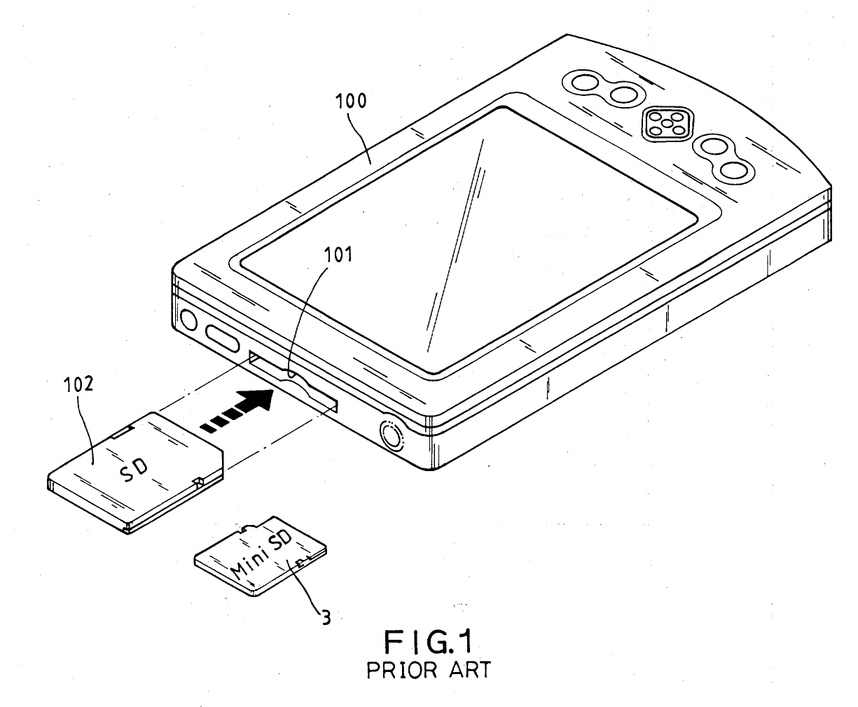

### DETAILED DESCRIPTION OF THE INVENTION

Referring to FIGS. from 2 through 10, a memory card adapter in accordance with the present invention is shown comprised of a housing 1, a set of terminals 2, a cartridge 4, and a retaining spring 5.

The housing 1 is shaped like a SD (Secure Digital) card and insertable to the SD (Secure Digital) card slot of an electronic mobile apparatus, comprised of a bottom cover shell 11 and a top cover shell 12. The bottom cover shell 11 comprises a front terminal holder 111 and a rear mini memory card chamber 113. The terminal holder 111 comprises a plurality of slots 112 for the passing of the terminals 2. The terminals 2 are mounted in the terminal holder 111, each having a front end 21 respectively extended out of the slots 112 and closely attached to the bottom surface of the bottom cover shell 11 and a rear end 22 extended to the inside of the rear mini memory card chamber 113. When the memory card adapter inserted into the SD (Secure Digital) card slot of an electronic mobile apparatus, the exposed front ends 21 of the terminals 2 are respectively forced into contact with the respective contacts in the SD (Secure Digital) card slot of the electronic mobile apparatus. The rear mini memory card chamber 113 is adapted to accommodate a mini SD (Secure Digital) card 3. The bottom cover shell 11 further comprises a positioning portion 110 in the rear side of the rear mini memory card chamber 113, a recessed portion 114 in one lateral side of the rear mini memory card chamber 113, two pivot holes 115 in the two opposite lateral sides of the rear mini memory card chamber 113 adjacent to the front terminal holder 111, and a beveled guide face 116 in one lateral side of the rear mini memory card chamber 113 opposite to the recessed portion 114. The top cover shell 12 comprises an opening 121 corresponding to the rear mini memory card chamber 113, a side hole 122 near one rear corner, a beveled guide face 123 in one lateral side of the opening 121 corresponding to the beveled guide face 116 of the bottom cover shell 11, and a locating notch 124 in one lateral side of the opening 121 corresponding to the recessed portion 114 of the bottom cover shell 11.

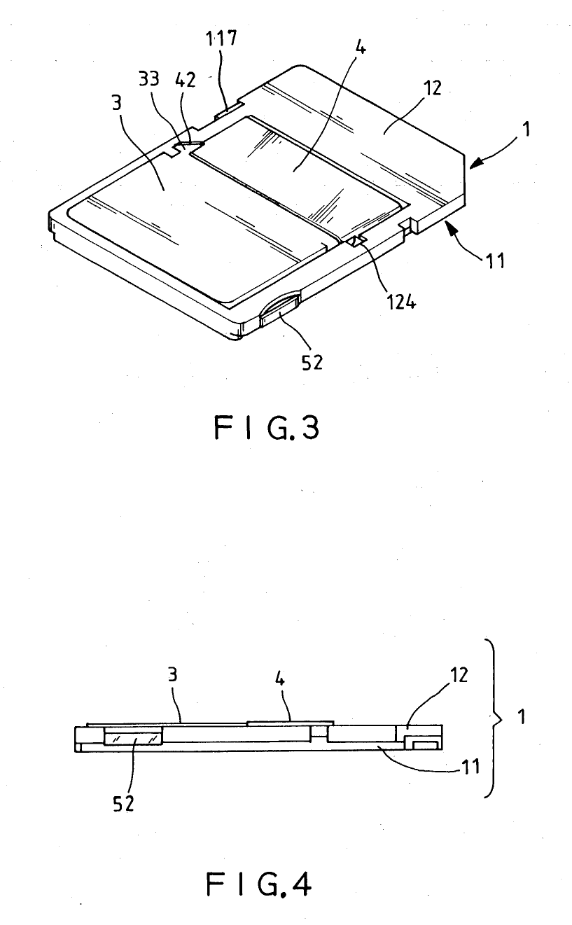

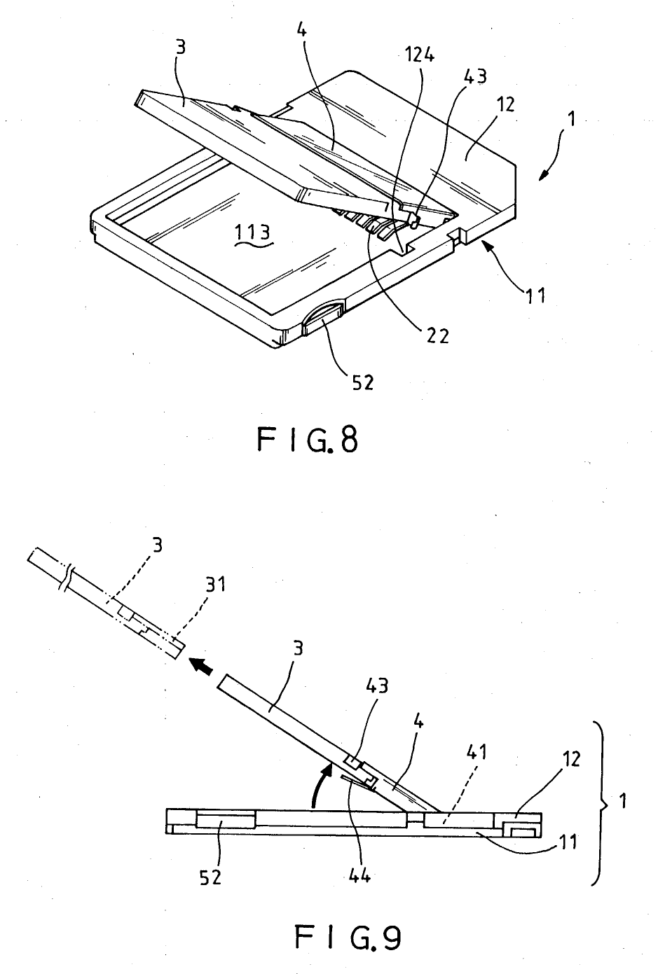

The cartridge 4 is a metal casing having a close top side and middle-opened bottom side and mounted in the bottom cover shell 11 within the opening 121 of the top cover shell 12. The cartridge 4 comprises tow lugs 41 bilaterally disposed near the front side and respectively pivoted to the pivot holes 115 in the rear mini memory card chamber 113 of the bottom cover shell 11 for enabling the cartridge 4 to be turned relative to the housing 1 between a first (horizontal) position where the cartridge 4 is received inside the opening 121 of the top cover shell 12 as shown in FIG. 3, and a second (lifted) position where the cartridge 4 is extended to the outside of the housing 1 as shown in FIG. 8, a guide strip 42 located on the left lateral side corresponding to the beveled guide faces 116 and 123 of the cover shells 11 and 12 of the housing 1, a retaining strip 43 located on the right lateral side and adapted to engage the recessed portion 114 of the bottom cover shell 11 and the locating notch 124 of the top cover shell 12, and a springy ejector arm 44 obliquely downwardly extended from the rear side for pressing on the bottom wall of the rear mini memory card chamber 113 when the cartridge 4 turned to the first position.

The retaining spring 5 is a resilient metal spring strip, having a rear mounting end 51 fixedly fastened to the positioning portion 110 upon sealing of the top cover shell 12 to the bottom cover shell 11 by a high frequency sealing apparatus, a front retaining end 53 adapted to engage the retaining strip 43 of the cartridge 4, and a protruding middle operation portion 52 suspending in the side hole 122 of the top cover shell 12 for pressing by the user.

As indicated above, the rear mini memory card chamber 113 is adapted to accommodate a mini SD (Secure Digital) card 3. The mini SD (Secure Digital) card 3 has a front side 31 insertable into the cartridge 4, a set of contacts 32 (not shown) located on the bottom side and adapted to contact the rear ends 22 of the terminals 2, and a beveled guide face 33 located on one lateral side corresponding to the guide strip 42 of the cartridge 4.

Further, there is a write protection shutter 117 provided in between the bottom cover shell 11 and the top cover shell 12 at one lateral side adjacent to the terminal holder 111. Because the write protection shutter 117 is of the known art and not within the scope of the claims of the present invention, no further detailed description in this regard is necessary.

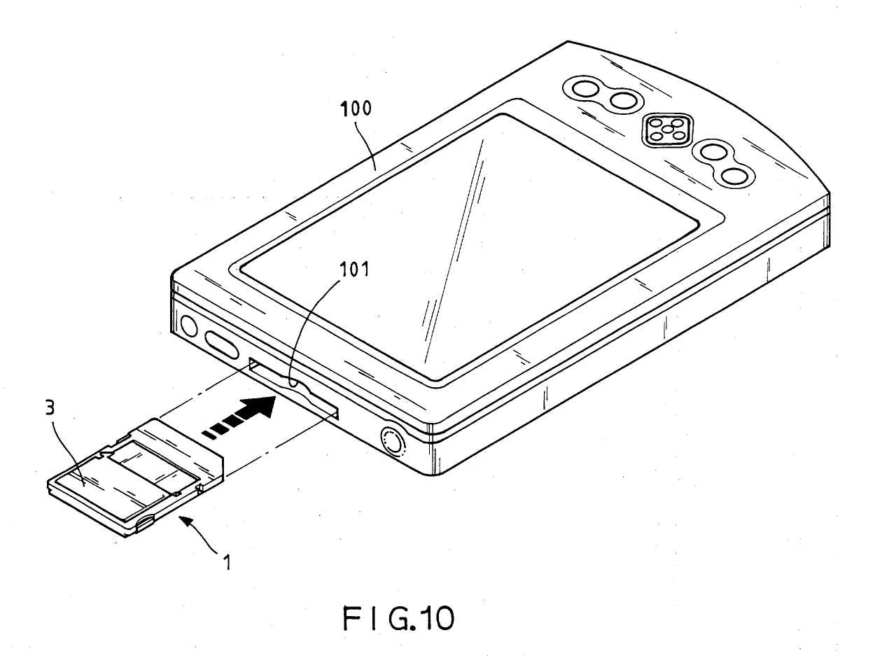

FIGS. 3 and 4 show the outer appearance of the memory card adapter when assembled. AS illustrated, the housing 1 is shaped like a conventional SD (Secure Digital) card, and insertable to the SD (Secure Digital) card slot 101 of an electronic mobile apparatus (for example, a PDA) 100 for enabling the located mini SD (Secure Digital) card 3 to be electrically connected to the electronic mobile apparatus 100 (see FIG. 10).

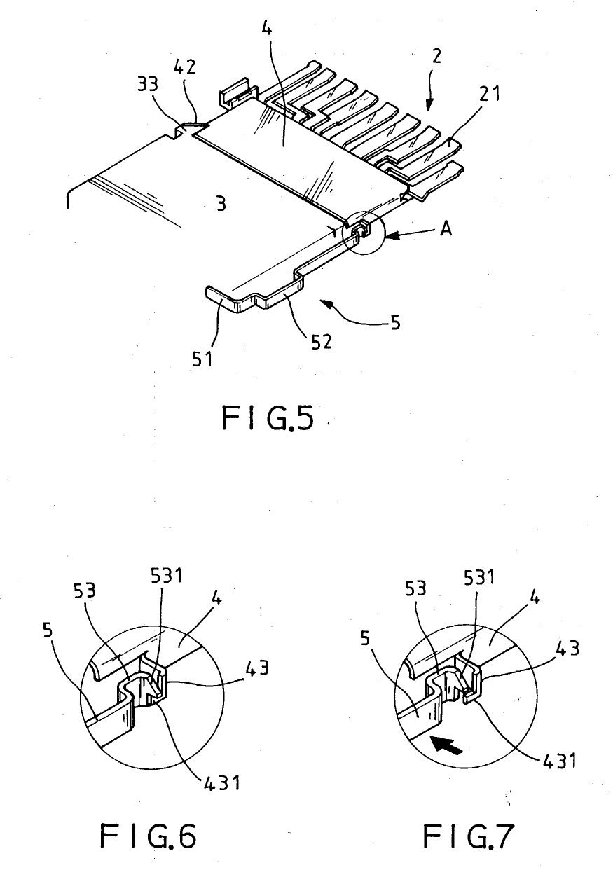

When turning the mini SD (Secure Digital) card 3 with the cartridge 4 from the second (lifted) position as shown in FIG. 8 to the first (horizontal) position as shown in FIG. 5, the retaining strip 43 is moved over the top sloping guide face 531 of the front retaining end 53 of the retaining spring 5 to force the hooked portion 431 of the retaining strip 43 into engagement with the front retaining end 53 of the retaining spring 5 at the bottom side of the top sloping guide face 531 as shown in FIG. 6. At this time, the mini SD (Secure Digital) card 3 is held in the housing 4 by the cartridge 4 to form with the housing 4 a SD (Secure Digital) card.

Referring to FIGS. 5, 7, 8, and 9, when the user pressed the operation portion 52 of the retaining spring 5 with the finger, the front retaining end 53 is disengaged from the retaining strip 43 of the cartridge 4. At this time, the springy ejector arm 44 returns to its former shape to force the cartridge 4 upwards from the bottom cover shell 11, thereby causing the mini SD (Secure Digital) card 3 to be turned with the cartridge 4 from the first (horizontal) position to the second (lifted) position, for enabling the user to remove the mini SD (Secure Digital) card 3 from the cartridge 4 (see FIG. 9).

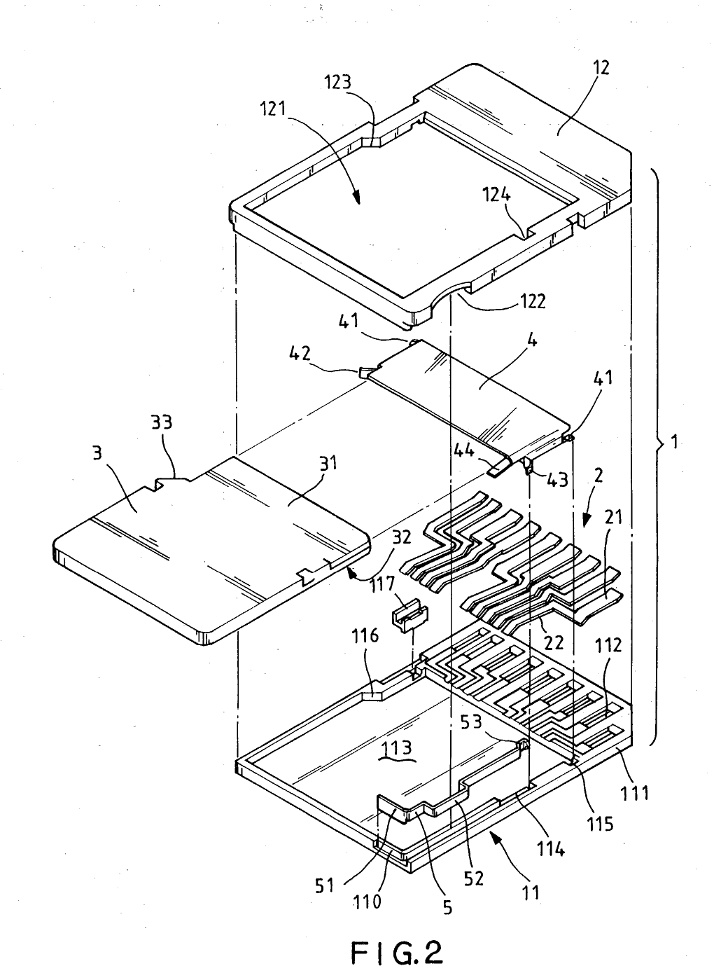

A prototype of memory card adapter has been constructed within the features of FIGS. 2-10. The memory card adapter functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A memory card adapter comprising:
a housing shaped like a SD (Secure Digital) card and insertable to the SD (Secure Digital) card slot of an electronic apparatus, said housing comprising a bottom cover shell and a top cover shell covering said bottom cover shell, said bottom cover shell comprising a front terminal holder, a rear mini memory card chamber adapted to accommodate a mini memory card, a positioning portion in a rear side thereof, and a recessed portion in one lateral side thereof, said top cover shell comprising an opening corresponding to the rear mini memory card chamber of said bottom cover shell, a side hole, and a locating notch in one lateral side of said opening corresponding to the recessed portion of said bottom cover shell;
a plurality of terminals respectively mounted in said terminal holder, said terminals each having a rear end respectively extended into said rear mini memory card chamber of said bottom cover shell;
a cartridge mounted in the rear mini memory card chamber of said bottom cover shell of said housing and turned in and out of the opening of said top cover shell between a horizontal position and a lifted position and adapted to accommodate a mini memory card and to hold the inserted mini memory card in contact with the rear ends of said terminals when said cartridge set in said horizontal position, said cartridge comprising two lugs symmetrically provided at two opposite lateral sides thereof and respectively pivoted to two opposite lateral sides of said rear mini memory card chamber of said bottom cover shell, and a retaining strip located on one lateral side; and
a retaining spring mounted in said bottom cover shell and adapted to lock said cartridge in said horizontal position, said retaining spring having a rear mounting end fixedly fastened to the positioning portion of said bottom cover shell, a front retaining end adapted to engage the retaining strip of said cartridge, and a protruding middle operation portion suspending in the side hole of said top cover shell for pressing by the user to disengage said front retaining end from the retaining strip of said cartridge.

2. The memory card adapter as claimed in claim 1, wherein said cartridge is a metal casing; said retaining strip of said metal casing is a metal member integral with said metal casing, having a hooked portion for hooking the front retaining end of said retaining spring; said retaining spring is a metal spring strip, having a top sloping guide face in the front retaining end.

3. The memory card adapter as claimed in claim 1, wherein said mini memory card is a mini SD (Secure Digital) card.

4. The memory card adapter as claimed in claim 1, wherein said cartridge comprises a guide strip extended from one lateral side thereof and adapted to guide movement of said cartridge between said horizontal position and said lifted position, and a springy ejector arm obliquely downwardly extended from a rear side thereof for pressing on a bottom wall of said rear mini memory card chamber when said cartridge turned to said horizontal position and forcing said cartridge outwards from said horizontal position to said lifted position when said retaining spring disengaged from said retaining strip of said cartridge.
